(19) United States
(12) Patent Application Publication
(10) Pub. No.: US 2022/0277331 A1
(43) Pub. Date: Sep. 1, 2022

(54) SYSTEMS AND METHODS FOR PROCUREMENT COST FORECASTING

(71) Applicant: Complete Intelligence Technologies, Inc., The Woodlands, TX (US)

(72) Inventors: Anthony Nash, Spring, TX (US); Robert Bryngelson, Spring, TX (US)

(21) Appl. No.: 17/754,554

(22) PCT Filed: Oct. 29, 2020
(86) PCT No.: PCT/US2020/057997

§ 371 Date: Apr. 5, 2022

Related U.S. Application Data
(60) Provisional application No. 62/928,292, filed on Oct. 30, 2019.

(51) Int. Cl. G06Q 30/02; G06Q 10/08; G06Q 30/06

(52) U.S. Cl. CPC G06Q 30/0206; G06Q 10/087; G06Q 30/0201; G06Q 30/0633

(57) ABSTRACT

Systems and methods for automatically predicting component procurement costs using machine learning and a procurement cost forecasting platform are herein disclosed. In one example, a method for a procurement cost forecasting platform comprises, collecting component procurement cost data for a component, pre-processing the component procurement cost data to produce screened and tested component procurement cost data, acquiring historical data, pre-processing the historical data to produce screened and tested historical data, determining a component procurement cost forecast for the component over a pre-determined future duration using a composite machine learning model, the screened and tested component procurement cost data, and the screened and tested historical data, wherein the composite machine learning model comprises a plurality of models, wherein each of the plurality of models comprises one or more internal parameters, and one or more associated weights, and displaying the component procurement cost forecast to a user via a graphical user interface.

### TECHNICAL FIELD

Embodiments of the subject matter disclosed herein relate to procurement cost forecasting, and more particularly, to systems and methods for automatically determining procurement cost forecast using machine learning.

### BACKGROUND AND SUMMARY

The risks that impact manufacturing supply chains are continuously growing and changing. Supply chains can be impacted by distribution disruptions, government regulations, labor concerns, competition, commodity and raw material prices, general economic conditions, environmental impact, international trade agreements, cyber risk, and currency risk. Each of these risks can impact the price of purchasing components used in the manufacturing process and thus the end price of any products made from these components. The inability to forecast procurement costs for specific items used in the manufacturing process forces companies to assume a large amount of risk. This assumption of risk leads to inefficiencies in both the manufacturing and procurement process, resulting in added cost to the product so that companies can ensure a constant volume supply of goods, decreasing gross margins, and ultimately leading to higher pricing and lower profitability.

While a large number of cost forecasting models exist, choosing an appropriate model or models for a given industry, company, or item, may be difficult and require a human expert to manually select/tune the cost forecasting model(s), as cost patterns for different items or industries may vary. The various cost forecasting models may use different data sets, and produce contradictory results, making implementation of current cost forecasting models, as well as interpretation of the resultant procurement cost forecasts, time consuming and difficult. Further, such models may not analyze data relevant to a specific product of a particular company, or the specific components of a product for a specific company. Thus, existing cost forecasting models may be too general to provide actionable information as they on higher level forecasting and do not take into consideration a company's own data.

The inventors herein have developed systems and methods which may at least partially address the above issues. In a first embodiment, a method for automatically determining a procurement cost forecast for a component using a procurement cost forecasting platform comprises: collecting component cost data for a component from a company; pre-processing the component cost data to produce screened and tested component cost data; acquiring historical data; pre-processing the historical data to produce screened and tested historical data; determining a component procurement cost forecast for the component over a pre-determined future duration using a composite machine learning model, the screened and tested component cost data, and the screened and tested historical data, wherein the composite machine learning model comprises a plurality of models, wherein each of the plurality of models comprises one or more internal parameters, and one or more associated weights; and displaying the component procurement cost forecast to a user via a graphical user interface. In this way, a centralized procurement cost forecasting platform may determine procurement cost forecasts for a plurality of businesses and a plurality of components, using a composite machine learning model, wherein the composite machine learning model predicts a plurality of procurement cost forecasts with a plurality of models, and uses a machine learning based approach to synthesize the plurality of procurement cost forecasts into a single, robust, procurement cost forecast which can be applied with the desired level of granularity. This enables automatic and efficient procurement cost forecasting by tailoring the parameters of the forecasting model on a component-by-component basis to a company's specific requirements.

In a second embodiment, a procurement cost forecasting platform comprises: a communication subsystem, wherein the communication subsystem communicably couples the procurement cost forecasting platform with a client device, one or more historical data sources, and an enterprise device; a data holding subsystem comprising machine readable instructions; and a logic subsystem, wherein, when executing the machine readable instructions, the logic subsystem is configured to collect component procurement cost data of a component from the enterprise device, pre-process the component procurement cost data to produce screened and tested component procurement cost data, acquire historical data from the one or more historical data sources, pre-process the historical data to produce screened and tested historical data, determine a component procurement cost forecast for a component over a pre-determined future duration using a composite machine learning model, the screened and tested component procurement cost data, and the screened and tested historical data, and transmit the component procurement cost forecast to the client device via the communication subsystem. In this way, a procurement cost forecasting platform may determine a component procurement cost forecast using data obtained from a client's enterprise device, enabling context specific procurement cost forecasting.

In a third embodiment, a method for a procurement cost forecasting platform comprises: collecting first component procurement cost data for a first component from an enterprise device of a client; pre-processing the first component procurement cost data to produce screened and tested first component procurement cost data; mapping the screened and tested first component procurement cost data to a first plurality of component procurement cost forecasts using a plurality of models; aggregating the first plurality of component procurement cost forecasts to produce a first component procurement cost forecast; and displaying the first component procurement cost forecast to the client via a graphical user interface of a client device. In this way, the procurement cost forecasting platform may determine a procurement cost forecast for a client with the desired level of granularity using the client's own data, thereby enabling prediction of a procurement cost forecast specific to the client's market and business. Further, by displaying the procurement cost forecast via a graphical user interface of the client's device, a client may more easily access and view the component procurement cost forecast.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE FIGURES

FIG. 1 shows an example of a procurement cost forecasting system comprising a procurement cost forecasting platform.

FIG. 2 shows an example of a computing environment capable of implementing a procurement cost forecasting platform.

FIG. 3 shows a flowchart of an example method for determining a procurement cost forecast for a component of a product.

FIG. 4 shows a flowchart of an example method for determining a procurement cost forecast for a component using a composite machine learning model.

FIGS. 5-7 show example graphical user interfaces (GUIs) of the procurement cost forecasting platform.

### DETAILED DESCRIPTION

Systems and methods are disclosed herein for forecasting procurement costs of product components using a procurement cost forecasting platform implementing a composite machine learning model. Currently, companies may not be able to accurately forecast component procurement costs at regular intervals (monthly, weekly, quarterly, etc.) for specific product components, then roll those low-level procurement cost forecasts into product procurement cost forecasts, product category procurement cost forecasts, business unit procurement cost forecasts, etc. To date, this has been viewed as technically challenging given the volume of data, the type of data, the varying quality of the data (e.g., missing data points, incorrectly formatted data, etc.), and calculations required. The inability to perform this kind of forecast means that companies accept a large amount of risk in their supply chains and manufacturing processes. This may materialize as added cost to the product so that companies can ensure a constant volume supply of goods, impacting both consumers and company bottom lines.

The current disclosure may enable forecasting procurement costs with the desired level of granularity, whether at the level of the business unit, product categories, individual products, or product components, using clients' own data from their internal systems, e.g., Enterprise Resource Planning (ERP), eProcurement, Supply Chain Management (SCM), or other enterprise systems, along with billions of publicly available data points from the global economy and global markets using a procurement cost forecasting platform. The procurement cost forecasting platform may enable forecasting of component procurement costs that can be aggregated into product procurement costs, product category procurement costs, and so forth, so that companies may have a specific view on procurement costs at specific time intervals (e.g., monthly for the next 12 months). The current disclosure may therefore enable companies to better account for future cost fluctuations, which may further enable companies to better negotiate with vendors or hedge against future component cost changes.

Further, the current disclosure may at least partially address the technical challenge associated with predicting costs for a range of items which may display substantially different cost patterns, e.g., costs for some items may be strongly impacted by seasonal/cyclical price variations, costs for other items may correlate with the news, and others may correlate with long term trends like changing global demographics, while others may correlate more strongly with a first feature during a first paradigm, and may correlate more strongly with a second feature during a second paradigm. The current disclosure may enable more accurate cost forecasting for a range of items which display different cost patterns by utilizing a plurality of base models, each of which may specialize in modeling a particular subset of cost patterns (e.g., a first base model may specialize in predicting costs for long term linear price movement, a second base model may specialize in predicting cyclical cost patterns, and a third base model may specialize in predicting costs on short timescales). The inventors herein unexpectedly found a means for intelligently combining and integrating cost forecasts from a plurality of specialized base models, to produce bespoke composite models based on item, which may enable more accurate cost prediction for a wider range of items and over a wider range of timescales. In some examples, base models may include statistical models (e.g., models having learned parameters, such as neural networks, regression models, Markov models, etc.) as well as analytical models (models with explicitly defined parameters).

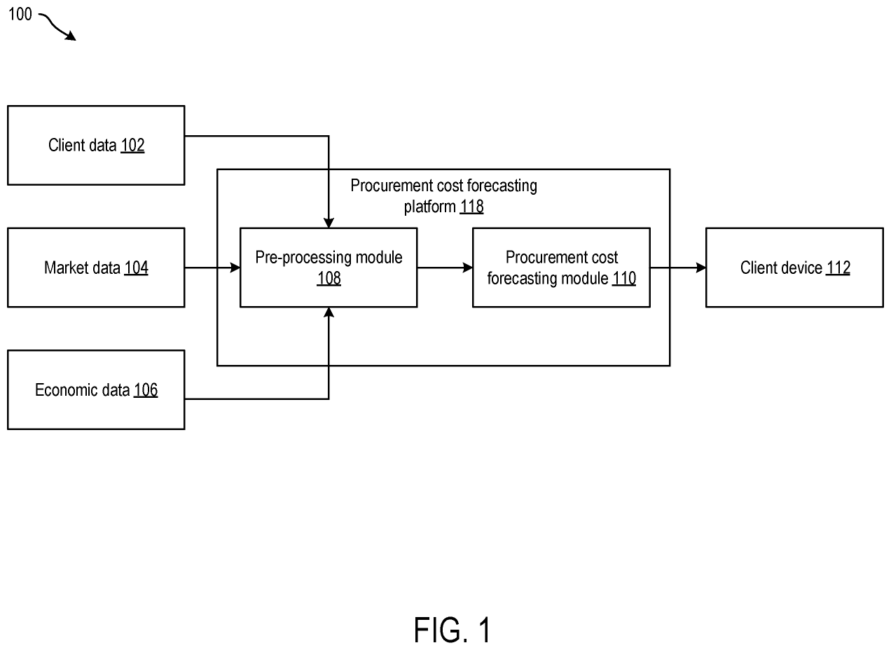

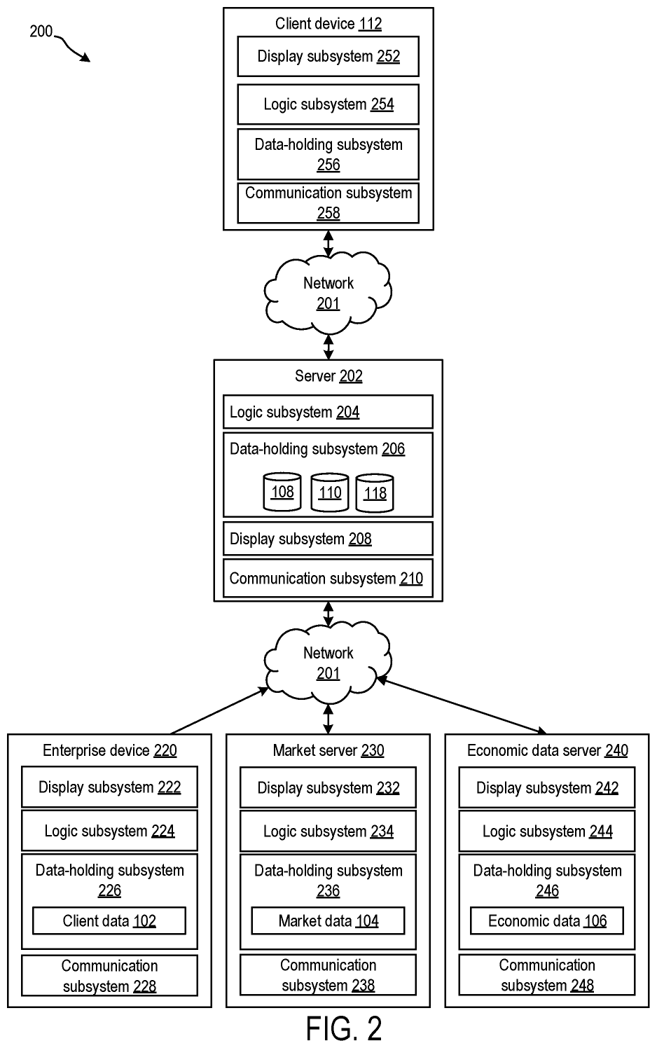

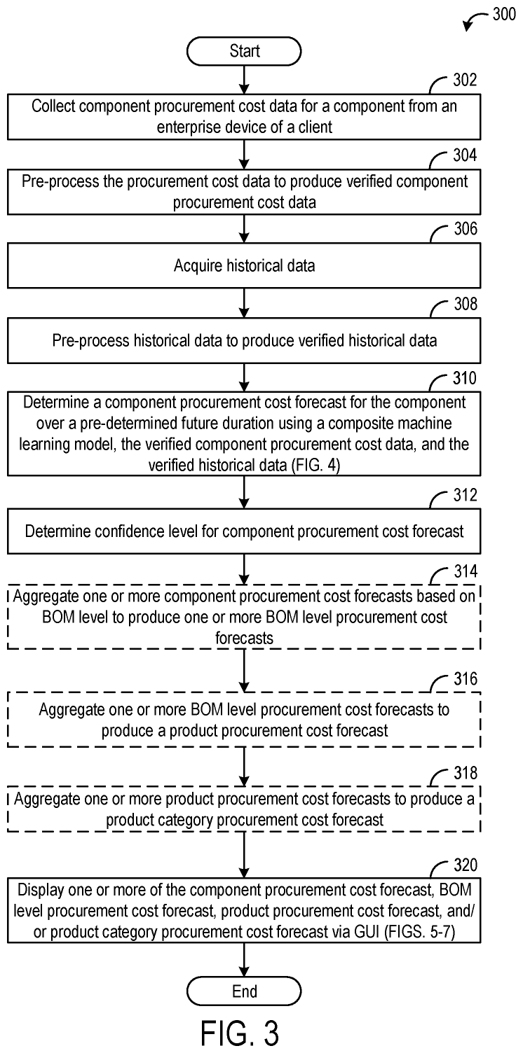

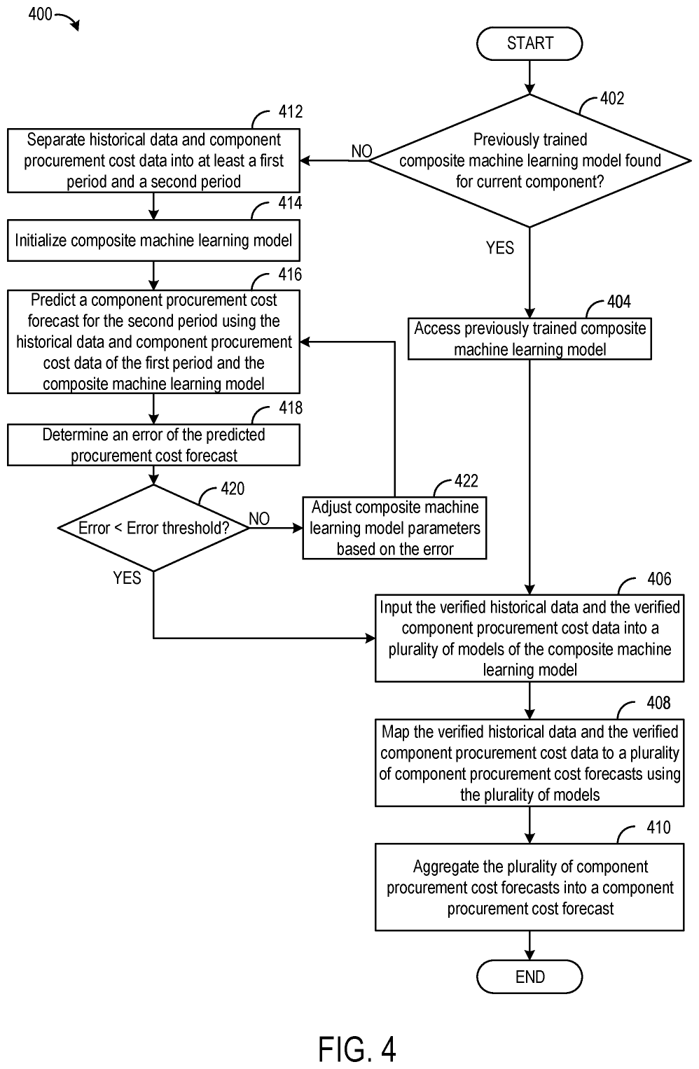

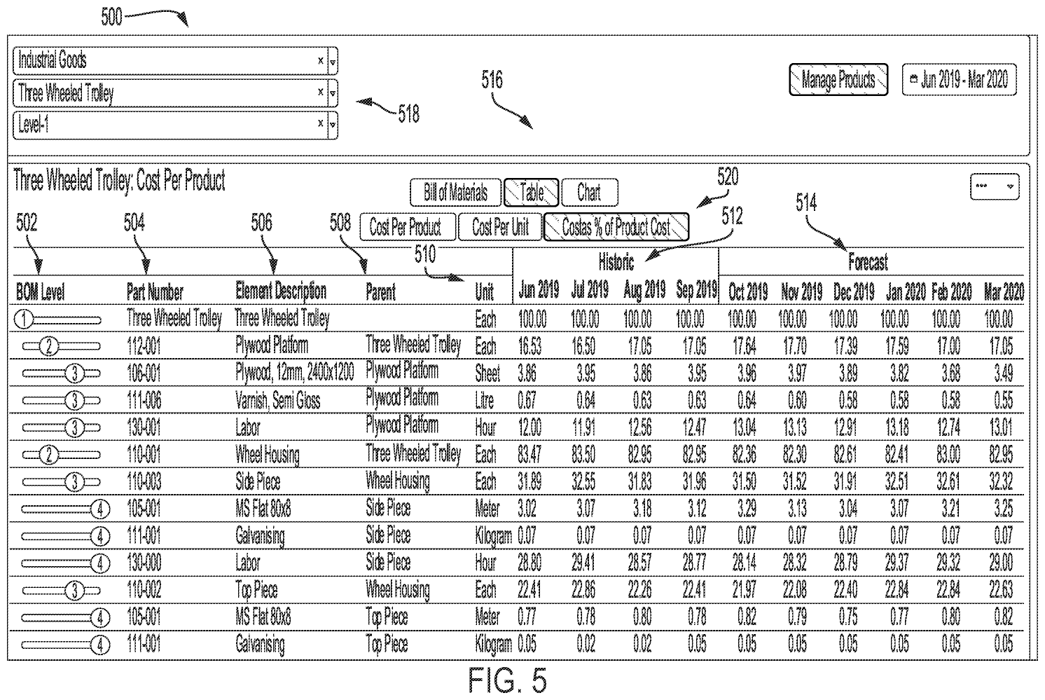

In one embodiment, the current disclosure provides for a procurement cost forecasting platform, as shown in FIG. 1, which may be implemented by the computing environment of FIG. 2. The procurement cost forecasting platform may execute one or more of the steps of methods 300 and 400, shown in FIGS. 3 and 4, respectively, to determine a procurement cost forecast for one or more product components, using a composite machine learning model. The procurement cost forecasting platform may display the one or more procurement cost forecasts via one or more of the graphical user interfaces (GUIs) illustrated in FIGS. 5-7.

As used herein, a component, element, product element, or product component and other similar terms, will be understood to refer to an item (e.g., varnish, plywood, bolt, etc), or resource (e.g., labor, electricity, etc.), used in the manufacture of a product. A product may comprise one or more components and/or the manufacture of a product may require use of one or more components. Components, products, product categories and business units may be categorized hierarchically, for example using a bill-of-material (BOM). For example, a finished product may belong to a first, highest, BOM level, which may in turn comprise subunits of a second, lower BOM level, and each subunit of the second BOM level may in turn comprise additional subunits or components of a third, lower BOM level, and so on. Each subsequent BOM level may comprise simpler product subunits. For example, a vehicle (a product) may belong to a first, highest BOM level, and a chassis, frame, engine assembly, etc. may belong to a second, lower BOM level. Subcomponents of the engine assembly, e.g., the pistons, the drive shaft, the intake manifold, etc. may belong to a third, lower BOM level. Parts of for the subcomponents, such as a universal joint or torque tube of the drive shaft may belong to a fourth, lower BOM level. The bolts of the universal joint may belong to a fifth, lower BOM level. The metals or other materials used to make the bolts may belong to a sixth, lower BOM level. Procurement costs can be identified at each BOM level and/or aggregated at additional levels depending on the supply chain of the client.

Referring to FIG. 1, an example of a procurement cost forecasting system 100 is shown. Procurement cost forecasting system 100 comprises a procurement cost forecasting platform 118, communicably coupled to a plurality of data sources (client data 102, market data 104, and economic data 106), and a client device 112. The procurement cost forecasting platform 118 comprises a pre-processing module 108, which may receive, analyze, and repair data from the one or more data sources, and a procurement cost forecasting module 110, which may execute a method, such as methods 300 and 400 discussed in more detail below, to determine procurement cost forecasts for one or more components of one or more products of the client. The procurement cost forecasting platform 118 acquires/collects data from a plurality of sources and analyzes this data in the context of a specific client/product, to produce more accurate, and customized procurement cost forecasts. In one embodiment, the procurement cost forecasting platform 118 may employ procurement cost forecasting module 110 to train a composite machine learning model (discussed in more detail below, with reference to method 400 of FIG. 4) using a client's own data, which may include purchase orders for product components or offers and quotes received from vendors, as well as data obtained from third party data sources, to produce a bespoke composite machine learning model for a particular client. In some embodiments, a separate/distinct composite machine learning model may be trained for each product component of a client, thereby enabling a greater degree of specificity in the procurement cost forecasts produced.

Although the procurement cost forecasting platform 118 is shown communicably coupled with three data sources (client data 102, market data 104, and economic data 106), it will be appreciated that the current disclosure provides for the procurement cost forecasting platform 118 to be communicably coupled with more, fewer, or different data sources. Likewise, the current disclosure provides for the procurement cost forecasting platform 118 to be coupled to one, or more than one client devices. The example shown in FIG. 1 includes a single client device for simplicity and is not intended to be limiting in any way.

The procurement cost forecasting platform 118 may communicate with an enterprise device, such as enterprise device 220, discussed below in reference to FIG. 2, to collect client data 102. Client data 102 may comprise historical component procurement cost data (herein also referred to simply as component procurement cost data), which may indicate previous costs paid by a client for one or more product components. In some embodiments client data 102 may comprise component purchase orders, which may indicate a price of the component, a time of purchase (e.g., the purchase order may include a timestamp or date), information regarding the merchant(s) from which the component was sourced (e.g., geographical location of the merchant, merchant name, etc.), shipping fees/taxes, quantities ordered, component IDs (e.g., part numbers), a BOM level of the component, the product in which the component was used, currency used to make the purchase, exchange rate at the time of purchase, a geographical location of the client, an industry of the client, etc. Client data 102 may be submitted to the procurement cost forecasting platform 118 by a client via an enterprise device or may be actively collected by the procurement cost forecasting platform 118 via network communication with an enterprise device of the client. In one example, the procurement cost forecasting platform 118 may interface with an enterprise device of a client via an enterprise device application programming interface (API), to acquire client data 102.

The procurement cost forecasting platform 118 may further acquire historical data from one or more additional data sources. In the example shown in FIG. 1, historical data comprises market data 104 and economic data 106, although it will be appreciated that the current disclosure is not limited to market data and economic data, but may include substantially any publically accessible data relevant to a client's industry/line-of-business.

Market data 104 may be acquired from a market data source, such as market data server 230, discussed in more detail below with reference to FIG. 2, via network connection with the procurement cost forecasting platform 118. Market data 104 may be submitted to the procurement cost forecasting platform 118 by a market data server or may be actively collected by the procurement cost forecasting platform 118 via network communication with a market data server. In one embodiment, the procurement cost forecasting platform 118 may interface with a market data server via a market data server API or other network connection type to acquire historical and/or real time market data, for one or more markets. In some embodiments, market data may include real estate prices, labor rates, as well as other costs, volumes, and the like from government, publicly available and/or proprietary sources. In a non-limiting example, markets may include commodities markets (e.g., COMEX, ICE, etc.), equities markets (e.g., the NYSE, TSE, etc.), currency markets (e.g., FOREX), bond markets, and exchange traded fund (ETF) markets.

In some embodiments, market data 104 may comprise price charts, executed order prices and volumes, and other data pertaining to executed buy/sell transaction orders for one or more commodities/equities/currencies, placed with the market data server. Historical transaction data (including executed buy/sell orders) data may include timestamps indicating a time of the transaction, thereby enabling the procurement cost forecasting platform 118 to process/correlate the market data 104 with client data 102 and economic data 106 in time. Market data may further include geographically segmented data, indicating transaction volumes and prices on a national, regional, and/or local basis.

Economic data 106 may be acquired from an economic data source, such as economic data server 240, discussed in more detail below with reference to FIG. 2, via network connection with the procurement cost forecasting platform 118. In one embodiment, the procurement cost forecasting platform 118 may interface with an economic data server via an economic server API or other network communication types to acquire historical and/or real time economic data, for one or more countries, trade alliances, regions, industries, etc. In one example economic data 106 may include gross domestic product (GDP) data, trade data (e.g., import and export data for one or more countries/regions), inflation data, population data (e.g., census data), unemployment data, consumer price index data (CPI data), etc. Economic data 106 may include a timestamp, or other indication of time/date, indicating periods over which the economic data is relevant/applicable. In one example, GDP data may be calculated on an annual basis, and each GDP data point may have an associated date. In another example, economic data 106 may comprise time-lines of one or more economic parameters, such as inflation, showing change in inflation rate as a function of time. This may enable the procurement cost forecasting platform to correlate/align the economic data 106 with the market data 104 and client data 102, such that events in one type of data may be processed with events in the other types of data, in time. In one non-limiting example, a change in a one or more economic variables, e.g., trade of manufactured goods between US and China, unemployment rate in Mexico, industrial production in Japan, etc., may be correlated with a change in component procurement cost over the same period of time.

The procurement cost forecasting platform 118 may direct the collected/acquired client data 102, market data 104, and economic data 106, to pre-processing module 108. The pre-processing module 108 includes computer readable (machine readable) instructions for analyzing incoming data, identifying anomalies, missing data, and suspected errors, in said data, and correcting the anomalies, missing data, and suspected errors. In some embodiments, the pre-processing module may separately pre-process the client data 102, the market data 104, and the economic data 106, which may have different rules/algorithms for identifying anomalies, missing data, and suspected errors. Further, the pre-processing module may extract features of the input data, such as component names, component part numbers, BOM level of a component, quantities of components used (per product, per BOM level, etc.), and may further index the data in time such as by tagging each input record with a timestamp determined by correlation or other processing method with other input data, or other means.

In one example, the pre-processing module 108 may detect and remove anomalies in one or more of client data 102, market data 104, and economic data 106. Anomalies may comprise one-time events or fluctuations in one or more parameters through time, which do not reflect long term trends or seasonality, but which instead represent one-off phenomena, such as a natural disaster, an accident (e.g., oil tanker crash etc.), scandal, pandemic impact, etc. In one example, the pre-processing module may include one or more threshold rates of change, and upon a parameter exceeding a threshold rate of change, the pre-processing module 108 may flag the period over which the parameter rate of change exceeded the threshold rate of change. The pre-processing module may then excise data over the flagged period of time and may replace the excised data using interpolated data or data synthesized using other functions to fill the gap in the data. In one example, the pre-processing module 108 may include a generative machine learning algorithm trained to synthesize missing data for a period of time. In one embodiment, the machine learning algorithm may comprise an ensemble approach and/or a neural network. The inventors herein unexpectedly found that by removing one-off/black-swan events, cost prediction accuracy may be substantially improved.

By smoothing the data in this way, seasonal or other relevant trends may be more clearly visible, and may be more easily fit using one or more models, enabling more accurate cost forecasts. Similarly, the pre-processing module 108 may detect gaps/missing data in one or more of client data 102, market data 104, and economic data 106, and may attempt to repair said gaps or missing data by interpolating the missing data. In one example, the pre-processing module 108 may include an ensemble approach and/or a neural network trained to synthesize missing data for a period of time using the bookend data (the data preceding and following the gap). In some embodiments, the pre-processing module 108 may interpolate from 0% to 20% of contiguous missing data, or any fractional amount therebetween (e.g., 12.563% 0.25%, 15%, etc.). The pre-processing module 108 may further include machine readable instructions for identifying typographical errors or format errors, (e.g., a letter is used where a number is expected such as in 10.1).

The pre-processing module 108 may detect typographical errors/format errors by comparing the incoming data (e.g., client data 102, market data 104, and economic data 106) against one or more pre-determined format filters (e.g., by parsing the incoming data using regex). In some embodiments, the pre-processing module 108 may determine if a purchase order of the one or more purchase orders included in client data 102 includes a timestamp, and may respond to the purchase order not including the timestamp by removing the purchase order from the component procurement cost data to produce the screened and tested component procurement cost data. In this way, the pre-processing module 108 may produce screened and tested client data (including screened and tested procurement cost data for one or more product components) and screened and tested historical data. By pre-processing the incoming data in this way, the pre-processing module 108 may facilitate more accurate procurement cost forecasting by the procurement cost forecasting module 110.

The procurement cost forecasting module 110 receives the screened and tested client data, and screened and tested historical data from the pre-processing module 108, and predicts one or more future procurement costs for a component (herein referred to as a component procurement cost forecast), using a composite machine learning model. In one example, the composite machine learning model comprises a plurality of analytical and machine learning models, each independently capable of predicting component procurement costs. In one embodiment, the plurality of models includes but is not limited to one or more a deep neural network; a recurrent neural network; an ensemble approach including autoregressive integrated moving average (ARIMA), correlation analysis, vector autoregression (VAR), decision trees (e.g. random forest), generalized autoregressive conditional heteroscedasticity (GARCH) and exponential smoothing. In one embodiment, the plurality of models may produce a plurality of component procurement cost forecasts for a single component, and the plurality of component procurement cost forecasts may be aggregated into a single component procurement cost forecast by intelligently weighting the predictions from each of the models, and aggregating the predictions into a composite prediction/forecast using one or more learned weights. In some embodiments, the plurality of component procurement cost forecasts may be neutrally weighted, e.g., the aggregate component procurement cost forecast may comprise an average of the plurality of component procurement cost forecasts. In other embodiments, an unweighted component procurement cost forecast, produced by one of the plurality of models, may be used as the component procurement cost forecast. In some embodiments, each of the plurality of models may be associated with a learned weight, wherein the procurement cost forecast of each of the plurality of models may be multiplied by an associated weight to produce a weighted procurement cost forecast. The plurality of weighted procurement cost forecasts may be summed to produce a procurement cost forecast of the composite machine learning model. In some embodiments, the sum of each of the plurality of learned weights may equal one. In other embodiments, the sum of the plurality of learned weights may be greater than one, or less than one, and an additional normalization step may occur (that is, the overall procurement cost forecast may be divided by the sum of the weights to produce a normalized procurement cost forecast).

The procurement cost forecasting platform 118 may transmit or broadcast the component procurement cost forecast to a communicably coupled client device 112, wherein the component procurement cost forecast may be displayed via one or more GUIs on a display subsystem of the client device 112. In one embodiment, the procurement cost forecasting platform 118 may transmit the component procurement cost forecast to a webpage, wherein a client may access the component procurement cost forecast via a web browser of the client device 112. In another embodiment, the procurement cost forecasting platform 118 may transmit the component procurement cost forecast to one or more of an enterprise resource planning (ERP) system, an eProcurment portal, an EPM (Enterprise Performance Management) system, or other system selected by the client. The selected system, such as the ERP system, eProcurment portal, and/or EPM system may comprise machine readable instructions for displaying the component procurement cost forecasting using a custom GUI developed by the client. The ERP system, eProcurment portal, and/or EPM system may further comprise computer readable (machine readable) instructions, that when executed, cause the system(s) to perform additional processing of the component procurement cost forecast, such as planning future component purchases, including purchase dates, determining vendors from which to source the component, as well as determining quantities of component to purchase. This may enable the client to hedge against risk by purchasing when component prices are relatively low whether due to actual price or currency fluctuations, compared to future predicted prices, or by abstaining from purchasing additional components until a time of a predicted price decrease.

Turning now to FIG. 2, computing environment 200 is shown. Computing environment 200 comprises another example embodiment of a procurement cost forecasting system 100, shown in FIG. 1. As such, elements of procurement cost forecasting system 100 previously described in FIG. 1, may not be described again in detail in the description of FIG. 2. Specifically, FIG. 2 emphasizes the hardware elements of the procurement cost forecasting system 100. However, not all of the hardware elements described in FIG. 2 may be required to practice the invention. Variations in the arrangement and type of the hardware elements may be made without departing from the spirit or scope of the invention.

Computing environment 200 includes server 202, implementing a procurement cost forecasting platform, such as procurement cost forecasting platform 118. Server 202 may acquire/collect historical data and component procurement cost data, from one or more data sources, including enterprise device 220, market data server 230, and economic data server 240. Server 202 may implement one or more steps of methods 300, and/or 400, discussed in detail below, with reference to FIGS. 3 and 4, respectively, to determine a procurement cost forecast using the acquired/collected data. In one embodiment, server 202 employs machine readable instructions stored in procurement cost forecasting module 110, stored in data holding subsystem 206, to train a composite machine learning model to map procurement cost data and historical data to a procurement cost forecast for one or more components, over a pre-determined future duration. The procurement cost forecast(s) produced in this way may be transmitted to client device 112, where a client may view the procurement cost forecast in one or more GUIs, displayed on display subsystem 252.

In the embodiment shown in FIG. 2, the procurement cost forecasting platform 118 is implemented on server 202. In some embodiments, server 202 may take the form of a mainframe computer, a desktop computer, a laptop computer, a tablet computer, a network computing device, mobile communication device, etc. In some embodiments, the procurement cost forecasting platform 118 may be implemented by a cloud computing service, that is, one or more aspects may be implemented by ubiquitous, convenient, on-demand network access to a shared pool of configurable computing resources that can be rapidly provisioned and released with minimal management effort or service provider interaction. Clouds may be private, public, or a hybrid of private and public, and may include Infrastructure as a Service (IaaS), Platform as a Service (PaaS) and Software as a Service (SaaS), such as, but not limited to, Amazon Web Services (AWS), Microsoft Azure, Google Cloud, Oracle Cloud, etc. In some aspects, the devices used for computing purposes or to provide cloud services may be referred to generically as machines.

In some embodiments, functionality of the procurement cost forecasting platform may be distributed amongst a plurality of computing devices. Server 202 includes logic subsystem 204, and a data-holding subsystem 206. Server 202 may optionally include a display subsystem 208, communication subsystem 210, and/or other components not shown in FIG. 2. For example, server 202 may also optionally include user input devices that receive mechanical motion, audio and/or visual inputs. Such inputs may be discrete or continuous. Exemplary user input devices include, but are not limited to, keyboards, digital pens and pencils, stylus, touchpad, trackball, mice, game controllers, scanners, joysticks, cameras, microphones, and/or touch screens.

Logic subsystem 204 may include one or more physical devices configured to execute one or more machine readable instructions. For example, logic subsystem 204 may be configured to execute one or more computer readable (machine readable) instructions that are part of one or more applications, services, programs, routines, libraries, objects, components, data structures, or other logical constructs. Such machine readable instructions may be implemented to perform a task, implement a data type, transform the state of one or more devices, or otherwise arrive at a desired result. Logic subsystem 204 may include one or more processors that are configured to execute software instructions. Additionally, or alternatively, the logic subsystem 204 may include one or more hardware or firmware logic machines configured to execute hardware or firmware instructions. Processors of the logic subsystem 204 may be single or multi-core, and the programs executed thereon may be configured for parallel or distributed processing. The logic subsystem 204 may optionally include individual components that are distributed throughout two or more devices, which may be remotely located and/or configured for coordinated processing. For example, the logic subsystem 204 may include several engines for processing and analyzing data. One or more aspects of the logic subsystem 204 may be virtualized and executed by remotely accessible networked computing devices configured in a cloud computing configuration.

Data-holding subsystem 206 may include one or more physical, non-transitory computer-readable devices configured to hold data and/or instructions executable by the logic subsystem 204 to implement the herein described methods and processes. When such methods and processes are implemented, the state of data-holding subsystem 206 may be transformed (for example, to hold different data). For example, the data-holding subsystem may comprise instructions for implementing procurement cost forecasting platform 118, including instructions for implementing pre-processing module 108 and procurement cost forecasting module 110. Data-holding subsystem 206 may include removable media and/or built-in devices. Data-holding subsystem 206 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 206 may include devices with one or more of the following characteristics: volatile, nonvolatile, dynamic, static, read/write, read-only, random access, sequential access, location addressable, file addressable, and content addressable. In some embodiments, logic subsystem 204 and data-holding subsystem 206 may be integrated into one or more common devices, such as an application-specific integrated circuit or a system on a chip.

It is to be appreciated that data-holding subsystem 204 includes one or more physical, non-transitory devices. In contrast, in some embodiments aspects of the instructions described herein may be propagated in a transitory fashion by a pure signal (for example, an electromagnetic signal) that is not held by a physical device for at least a finite duration. Furthermore, data and/or other forms of information pertaining to the present disclosure may be propagated by a pure signal.

When included, display subsystem 208 may be used to present a visual representation of data held by data-holding subsystem 206. As the herein described methods and processes change the data held by the data-holding subsystem 206, and thus transform the state of the data-holding subsystem 206, the state of display subsystem 208 may likewise be transformed to visually represent changes in the underlying data. Display subsystem 208 may include one or more display devices utilizing virtually any type of technology. Such display devices may be combined with logic subsystem 204 and/or data-holding subsystem 206 in a shared enclosure, or such display devices may be peripheral display devices.

When included, communication subsystem 210 may be configured to communicatively couple server 202 with one or more other computing devices, such as client device 112, enterprise device 220, market data server 230, and/or economic data server 240. Communication subsystem 210 may include wired and/or wireless communication devices compatible with one or more different communication protocols. As non-limiting examples, communication subsystem 210 may be configured for communication via network 201, which may comprise a wireless telephone network, a wireless local area network, a wired local area network, a wireless wide area network, a wired wide area network, the Internet, etc. In some embodiments, communication subsystem 210 may allow server 202 to send and/or receive messages to and/or from other devices via network 201, which in some embodiments may comprise the public Internet.

Enterprise device 220, market data server 230, economic data server 240, and client device 112, may include various hardware for storing software instructions, processing data and user input, and executing the software instructions responsive to said user inputs. In particular, enterprise device 220, market data server 230, economic data server 240, and client device 112 may include logic subsystems, and data-holding subsystems. As such, they may collectively be described herein for the sake of brevity.

Enterprise device 220, market data server 230, economic data server 240, and client device 112 may include logic subsystems 224, 234, 244, and 254, respectively, and data-holding subsystems 226, 236, 246, and 256, respectively. Enterprise device 220, market data server 230, economic data server 240, and client device 112, may optionally include display subsystems 222, 232, 242, and 252, respectively and/or communication subsystems 228, 238, 248, and 258, respectively, and/or other components not shown in FIG. 2. For example, enterprise device 220, market data server 230, economic data server 240, may also optionally include user input devices such as keyboards, mice, game controllers, cameras, microphones, and/or touch screens.

Logic subsystems 224, 234, 244, and 254 may include one or more physical devices configured to execute one or more instructions. For example, logic subsystems 224, 234, 244, and 254 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result. Logic subsystems 224, 234, 244, and 254 may include one or more processors that are configured to execute software instructions. Additionally, or alternatively, the logic subsystems 224, 234, 244, and 254 may include one or more hardware or firmware logic machines configured to execute hardware or firmware instructions. Processors of the logic subsystems 224, 234, 244, and 254 may be single or multi-core, and the programs executed thereon may be configured for parallel or distributed processing. The logic subsystems 224, 234, 244, and 254 may optionally include individual components that are distributed throughout two or more devices, which may be remotely located and/or configured for coordinated processing. One or more aspects of the logic subsystems 224, 234, 244, and 254 may be virtualized and executed by remotely accessible networking computing devices configured in a cloud computing configuration.

Data-holding subsystems 226, 236, 246, and 256, respectively, may include one or more physical, non-transitory devices configured to hold data and/or instructions executable by the logic subsystems 224, 234, 244, and 254 to implement the herein described methods and processes. When such methods and processes are implemented, the state of data-holding subsystems 226, 236, 246, and 256 may be transformed (for example, to hold different data). Data-holding subsystems 226, 236, 246, and 256 may include removable media and/or built-in devices. Data-holding subsystems 226, 236, 246, and 256 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystems 226, 236, 246, and 256 may include devices with one or more of the following characteristics: volatile, nonvolatile, dynamic, static, read/write, read-only, random access, sequential access, location addressable, file addressable, and content addressable. In some embodiments, logic subsystems 224, 234, 244, and 254 and data-holding subsystems 226, 236, 246, and 256 may be integrated into one or more common devices, such as an application-specific integrated circuit or a system on a chip.

In the example shown in FIG. 2, enterprise device 220, may store client data 102 in data holding subsystem 226. As discussed in more detail above, in reference to FIG. 1, client data 102 may comprise one or more pieces of data pertaining to a client's manufacturing processes, including component purchase orders, product specifications, etc. Similarly, market data server 230 and economic data server 240, may include market data 104, and economic data 106, within data holding subsystem 236 and data holding subsystem 246, respectively.

When included, display subsystems 222, 232, 242, and 252 may be used to present a visual representation of data held by data-holding subsystems 226, 236, 246, and 256. As the herein described methods and processes change the data held by the data-holding subsystems 226, 236, 246, and 256, and thus transform the state of the data-holding subsystems 226, 236, 246, and 256, the state of display subsystems 222, 232, 242, and 252 may likewise be transformed to visually represent changes in the underlying data. Display subsystems 222, 232, 242, and 252 may include one or more display devices utilizing virtually any type of technology. Such display devices may be combined with logic subsystems 224, 234, 244, and 254 and/or data-holding subsystems 246, 264, and 226 in a shared enclosure, or such display devices may be peripheral display devices.

When included, communication subsystems 228, 238, 248, and 258 may be configured to communicatively couple server 202, enterprise device 220, market data server 230, economic data server 240, and client device 112 via network 201. Communication subsystems 228, 238, 248, and 258 may include wired and/or wireless communication devices compatible with one or more different communication protocols. As non-limiting examples, communication subsystems 228, 238, 248, and 258 may be configured for communication via a wireless telephone network, a wireless local area network, a wired local area network, a wireless wide area network, a wired wide area network, etc. In some embodiments, communication subsystems 228, 238, 248, and 258 may allow server 202, enterprise device 220, market data server 230, economic data server 240, and client device 112 to send and/or receive messages to and/or from the other devices, via network 201, which may in some examples include the public Internet.

Turning to FIG. 3, a flowchart of an example method 300 for determining a component procurement cost forecast is shown. Method 300 may be executed by one or more of the systems described above. In one embodiment, method 300 may be executed by a procurement cost forecasting platform implemented in a computing environment, such as computing environment 200, shown in FIG. 2.

Method 300 begins at operation 302, wherein the procurement cost forecasting platform collects component procurement cost data for a component from an enterprise device of a client. By directly acquiring component procurement cost data from the enterprise device of a client, more accurate cost forecasts for said component may be obtained, as contextual factors may be embedded in the specific cost data for a specific client which may not be otherwise accessible. In one embodiment, operation 302 includes the procurement cost forecasting platform collecting one or more purchase orders for the component from an enterprise device, wherein the purchase orders indicate a cost of the component, a quantity of the component ordered by the client, and a time of placement of the purchase order for the component. In one embodiment, the procurement cost data may comprise a merchant from which the component was sourced, as well as shipping fees and/or other fees associated with procurement of the component.

At operation 304, the procurement cost forecasting platform pre-processes the procurement cost data to produce screened and tested component procurement cost data. The inventors herein encountered an unexpectedly high occurrence of one-off/black-swan events in raw cost data and historical data, which substantially reduced cost prediction accuracy. By automatically identifying and excising one-off events, or otherwise corrupted data, the inventors herein found cost forecast accuracy may be substantially improved. In one embodiment, operation 304 includes the procurement cost forecasting platform determining if a purchase order of the one or more purchase orders includes a timestamp, date, or other indication of a time of purchase of the component, and responding to the purchase order not including a timestamp or other indication of a time of purchase by filtering out the purchase order from the component procurement cost data to produce the screened and tested component procurement cost data. In some embodiments, at operation 304, the procurement cost forecasting platform may compare a format of the component procurement cost data against one or more pre-determined formats, and in response to the procurement cost data fitting/matching one or more of the pre-determined formats, the procurement cost forecasting platform may add the component procurement cost data to the screened and tested component procurement cost data. In some embodiments, at operation 304, the procurement cost forecasting platform may compare a format of the component procurement cost data against one or more pre-determined formats, and in response to the procurement cost data not fitting/matching the pre-determined formats, not including the component procurement cost data in the screened and tested component procurement cost data.

At operation 306, the procurement cost forecasting platform acquires historical data. In one embodiment, the procurement cost forecasting platform may access historical data through network communication with one or more data sources, such as market data server 230, economic data server 240, etc. to acquire one or more of market data, trade data, and economic data. Market data may comprise currency data, such as FOREX data, equity market data such as stock prices, and commodities price data. Economic data may comprise publicly accessible economic data, such as inflation rates, interest rates (e.g., Federal Reserve interest rate, mortgage interest rates, etc.), gross-domestic-product (GDP), trade data, as well as trade agreements, tariffs, tax data, etc. In one embodiment, trade data comprises bilateral trade data. In one example, the bilateral trade data may comprise trade data for 195 potential trading partners across approximately 1,500 industry sectors. In some embodiments, the procurement cost forecasting platform may select data sources based on the current component, wherein each component includes an associated list of relevant data sources/data types. The procurement cost forecasting platform may acquire historical data from the one or more data sources indicated by the associated data source list. In some embodiments, the procurement cost forecasting platform may have previously acquired relevant data for a current component, and operation 306 may comprise the procurement cost forecasting platform accessing the previously acquired relevant data from a location of non-transitory memory.

At operation 308, the procurement cost forecasting platform pre-processes historical data to produce screened and tested historical data. In some embodiments, the procurement cost forecasting platform may filter historical data based on a timestamp of the historical data. In one example, historical data falling within a range of time determined based on the component procurement cost data collected at operation 302 may be used to filter historical data to produce screened and tested historical data. In a more specific example, if component procurement cost data is available from 2011 to 2015, historical data for the range of time from 2011 to 2015 may be selectively chosen and set as screened and tested historical data. In another example, historical data lacking a timestamp, or other data allowing correlation of the historical data in time, the procurement cost forecasting module may reject/filter-out the historical data.

At operation 310, the procurement cost forecasting platform determines a component procurement cost forecast for the component over a pre-determined future duration using a composite machine learning model, the screened and tested component procurement cost data, and the screened and tested historical data, as discussed in more detail below, with reference to FIG. 4. Briefly, operation 310 includes the procurement cost forecasting module accessing a memory location where the composite machine learning model is stored, inputting the screened and tested component procurement cost data and the screened and tested historical data into the plurality of models of the composite machine learning model, mapping the screened and tested component procurement cost data and the screened and tested historical data to a plurality of component procurement cost forecasts using the plurality of models, and aggregating the plurality of component procurement cost forecasts to produce the component procurement cost forecast. In some embodiments, aggregating the plurality of component procurement cost forecasts to produce the component procurement cost forecast comprises determining a weighted average of the plurality of component procurement cost forecasts by multiplying each of the plurality of component procurement cost forecasts by one or more associated weights to produce a plurality of weighted component procurement cost forecasts, and averaging the plurality of weighted component procurement cost forecasts to produce the component procurement cost forecast. In some embodiments, operation 310 may include intelligently synthesizing an aggregate procurement cost forecast by producing a plurality of weighted average cost forecasts for a respective plurality of future durations, e.g., for a first future duration from time t1 to time t2, a first weighted average of base procurement cost forecasts may be used and during a second duration from t3 to t4 (where t3 occurs following t2) a second weighted average of the base procurement cost forecasts may be used. In some embodiments, the plurality of models may include one or more analytical models, and/or one or more machine learning models, including, but not limited to, a deep neural network; a recurrent neural network; an ensemble approach including autoregressive integrated moving average (ARIMA), correlation analysis, vector autoregression (VAR), decision trees (e.g. random forest), generalized autoregressive conditional heteroscedasticity (GARCH) and exponential smoothing.

At operation 312, the procurement cost forecasting platform determines a confidence level for the component procurement cost forecast produced at operation 310. In one embodiment, the confidence level for the component procurement cost forecast is based on the error of the composite machine learning model as determined during training/testing, as discussed in more detail below, with reference to operation 416 and operation 418, of FIG. 4. In one embodiment, the confidence level is determined by one standard deviation (above and below the base forecast output) distributed evenly over 12 months. In this embodiment, 1/12^{th} of on standard deviation is added for each successive month from the date of the forecast.

At operation 314, the procurement cost forecasting platform aggregates one or more component procurement cost forecasts based on BOM level to produce one or more BOM level procurement cost forecasts. Bill-of-materials levels (BOM levels) may be set by a client using a client device in communication with the procurement cost forecasting platform. BOM levels may subdivide a product into hierarchical levels of components depending on the supply chain of the client, wherein each BOM level may comprise one or more sub levels, or one or more components. As an example, a first level may be a product category, such as household goods. A second level may be a three wheeled trolley (a product). The three-wheeled trolley may comprise a wooden platform (a third level), consisting of 4 bolts, 5 wooden planks, and a metal frame (components), and a wheel assembly (a third level) comprising a wheel housing, an axle, varnish, labor (components). In the above example, aggregating procurement cost forecasts for the wheel housing, axle, varnish, and labor produces a procurement cost forecast for the wheel assembly (a BOM level). As in the example of the trolley, BOM levels may relate to raw materials, parts of products, the entire product, a product category or even a business unit.

At operation 316, the procurement cost forecasting platform aggregates one or more BOM level procurement cost forecasts to produce a product procurement cost forecast. Products may be defined by a client using a client device in communication with the procurement cost forecasting platform and may comprise one or more BOM levels. The sum of each BOM level procurement cost forecast for a pre-defined product is the product procurement cost forecast.

At operation 318, the procurement cost forecasting platform aggregates one or more product procurement cost forecasts to produce a product category procurement cost forecast. Product categories may be defined by a client using a client device in communication with the procurement cost forecasting platform and may comprise one or more products. The sum of each product procurement cost forecast of a pre-defined product category is the product category procurement cost forecast. Similarly, costs for product category procurement cost forecasts may be aggregated to business units or the company overall.

At operation 320, the procurement cost forecasting platform displays one or more of the component procurement cost forecast, BOM level procurement cost forecast, product procurement cost forecast, product category procurement cost forecast, and/or business level procurement cost forecast via GUI (FIGS. 5-7). Following operation 320, method 300 may end.

In this way method 300 may enable a centralized procurement cost forecasting platform to determine procurement cost forecasts for a plurality of businesses and a plurality of components, using a composite machine learning model, wherein the composite machine learning model predicts a plurality of procurement cost forecasts with a plurality of base models, and uses a machine learning based approach to synthesize the plurality of procurement cost forecasts into a single, robust, procurement cost forecast. This approach may at least partially address the long standing technical challenge associated with predicting costs for a range of items which may display substantially different cost patterns, e.g., costs for some items are strongly impacted by seasonal/cyclical price variations, costs for other items may correlate with the news, and others may correlate with long term trends like global warming, while others may correlate more strongly with a first feature during a first paradigm, and may correlate more strongly with a second feature during a second paradigm. The current disclosure enables more accurate cost forecasting for a range of items which display different cost patterns by utilizing a plurality of base models, each of which may specialize in modeling a particular subset of cost patterns (e.g., a first base model may specialize in predicting costs for long term linear price movement, a second base model may specialize in predicting cyclical cost patterns, and a third base model may specialize in predicting costs on short timescales). Thus, intelligently combining cost forecasts from a plurality of more specialized base models, to produce bespoke composite models based on item, may enable more accurate cost prediction for a wider range of items, and over a wider range of timescales. In some examples, base models may include statistical models (e.g., models having learned parameters, such as neural networks, regression models, Markov models, etc.) as well as analytical models (models with explicitly defined parameters).

Turning to FIG. 4, a flowchart of an example method 400 for determining a component procurement cost forecast using a composite machine learning model is shown. Method 400 may be executed by one or more of the systems described above. In one embodiment, method 400 may be executed by a procurement cost forecasting platform implemented in a computing environment, such as computing environment 200, shown in FIG. 2.

Method 400 begins at operation 402, where the procurement cost forecasting platform determines for the current component, if a previously trained composite machine learning model is stored in non-transitory memory. If at operation 402, the procurement cost forecasting platform determines that a previously trained composite machine learning model for the current component is stored in a location of non-transitory memory, method 400 proceeds to operation 404. At operation 404, the procurement cost forecasting platform accesses the previously trained composite machine learning model. In one embodiment, operation 404 includes the procurement module accessing a previously stored composite machine learning model from a location of non-transitory memory, wherein the location of non-transitory memory is pointed to by an entry in a composite machine learning model index of the procurement cost forecasting platform. The composite machine learning model may include supervised and unsupervised machine learning methodologies which may comprise substantially any supervised or unsupervised machine learning models known in the art of machine learning.

At operation 406, the procurement cost forecasting platform inputs the screened and tested historical data and the screened and tested component procurement cost data into a plurality of models of the composite machine learning model. In some embodiments, the procurement cost forecasting platform selectively divides the screened and tested historical data and the screened and tested component procurement cost data, prior to inputting the data into the composite machine learning model.

At operation 408, the procurement cost forecasting platform maps the screened and tested historical data and the screened and tested component procurement cost data to a plurality of component procurement cost forecasts using the plurality of models.

At operation 410, the procurement cost forecasting platform aggregates the plurality of component procurement cost forecasts to produce a single, aggregate, component procurement cost forecast. In one embodiment, the plurality of models may produce a plurality of component procurement cost forecasts for a single component, and the plurality of component procurement cost forecasts may be aggregated into a single component procurement cost forecast by intelligently weighting the predictions from each of the models, and aggregating the predictions into a composite prediction/forecast using one or more learned weights. In one example, the procurement cost forecasting platform may determine a weighted average component procurement cost forecast using the plurality of component procurement cost forecasts and a plurality of associated learned weights by multiplying each of the plurality of component procurement cost forecasts by a uniquely associated learned weight of the plurality of learned weights, to produce a plurality of weighted component procurement cost forecasts. The plurality of weighted component procurement cost forecasts may then be summed to produce a weighted average component procurement cost forecast, more simply referred to herein as the component procurement cost forecast.

In some embodiments, the plurality of component procurement cost forecasts may be neutrally weighted, e.g., the aggregate component procurement cost forecast may comprise an average of the plurality of component procurement cost forecasts. In other embodiments, an unweighted component procurement cost forecast, produced by one of the plurality of models, may be used as the component procurement cost forecast (e.g., when the weight for one of the plurality of models is 1, and the weight of the others of the plurality of models is 0).

However, if at operation 402 the procurement cost forecasting platform is unable to find a previously trained composite machine learning model for the current component, method 400 proceeds to operation 412.

At operation 412, the procurement cost forecasting platform separates the screened and tested component procurement cost data, and the screened and tested historical data, according to time, into at least a first period and a second period. That is, operation 412 comprises the procurement cost forecasting platform dividing the available data (the screened and tested historical data and the screened and tested procurement cost data), into at least screened and tested component procurement cost data of a first period and screened and tested component procurement cost data of a second period, and screened and tested historical data of a first period and screened and tested historical data of a second period. The first period and second period may comprise durations of time for which component procurement cost data is available, wherein the first period may or may not precede and not overlap with the second period. In some embodiments, the first period immediately precedes the second period, that is, the end of the first period and the beginning of the second period are separated by less than a threshold duration of time, wherein the threshold may, in some embodiments, be set to zero.

At operation 414, the procurement cost forecasting platform initializes a new composite machine learning model. In some embodiments, initialization of a composite machine learning model may comprise setting each of a plurality of parameters of the composite machine learning model according to a random distribution. In some embodiments, initialization of a composite machine learning model may comprise setting each of a plurality of parameters of the composite machine learning model to a plurality of pre-determined values for any of the supervised machine learning ensemble methodologies known in the art of machine learning. In one embodiment, operation 414 comprises the procurement cost forecasting model selecting parameter values from a previously trained composite machine learning model, and using the parameter values as the initial values of the parameters of the new composite machine learning model, thereby accelerating a rate of parameter convergence during subsequent training.

At operation 416, the procurement cost forecasting platform predicts a component procurement cost forecast for the second period using the historical data of the first period, and the component procurement cost data of the first period, using the composite machine learning model. In some embodiments, operation 416 includes the procurement cost forecasting platform feeding the screened and tested historical data of the first period, and the screened and tested component procurement cost data of the first period, to a plurality of models of the composite machine learning model (both supervised and unsupervised methodologies), wherein the plurality of models comprise internal parameters, used for determining each of a plurality of component procurement cost forecasts, and a plurality of associated weightings, used for determining a weighted allocation of the plurality of component procurement cost forecasts.

At operation 418, the procurement cost forecasting platform determines an error of the predicted component procurement cost forecast. In one embodiment, operation 418 comprises the procurement cost forecasting platform calculating an error for the predicted component procurement cost forecast using a loss function, wherein the loss functions receives the predicted component procurement cost forecast for the second period, and the screened and tested component procurement cost data of the second period, and determines an error (also referred to as a loss) using a pre-defined function (the loss function). In one embodiment, the loss function may comprise a mean-squared-error loss function. In some embodiments, the loss function may comprise a Mean Absolute Percent Error (MAPE). In another embodiment, the loss function may comprise substantially any loss function known in the art of machine learning.

At operation 420, the procurement cost forecasting platform compares the error determined at operation 418 against a pre-determined error threshold. The error threshold may be a non-zero value, pre-determined by the procurement cost forecasting platform, and/or the client, and may represent an acceptable degree of error for a procurement cost forecast. A tradeoff exists between achieving low error for the predicted component procurement cost forecast, and generalizability of the composite machine learning model, as achieving a very low error for the predicted component procurement cost forecast may correlate with overfitting of the training data (in this case, the training data is the screened and tested component procurement cost of the first period, the screened and tested historical data of the first period, and the screened and tested component procurement cost of the second period), reducing the accuracy of the cost forecasts produced by the composite machine learning model on new data. In one embodiment, an error threshold of between 5% and 15% or any subset thereof may be selected.

Although the flowchart of FIG. 4 teaches adjusting ensemble model parameters based on an ensemble model error exceeding an error threshold, it will be appreciated that the current disclosure also encompasses periodically re-adjusting model parameters, regardless of an error of the ensemble model. In some embodiments, ensemble model parameters may be re-adjusted at regular intervals (monthly, weekly, or more frequently) to balance the lowest error from the methodological ensemble with the historical training of the composite machine learning model given the previous seasonal, periodic, systemic or other behavior for that specific forecast item.

If at operation 420 the procurement cost forecasting module determines that the error of the predicted component procurement cost forecast is greater than the error threshold, method 400 may proceed to operation 422, where one or more parameters of the composite machine learning model are adjusted based on the error. In one example, the error may be backpropagated through each of the plurality of models of the composite machine learning model, using a backpropagation algorithm. In one embodiment, a weight, used to determine a model's relative contribution to a predicted component procurement cost forecast, may be adjusted by multiplying the weight by the partial derivative of the error with respect to the weight, and subtracting the product of this multiplication from the previous weight, to produce an updated weight. In some embodiments, a step size parameter between may also be specified, and may be used to adjust the rate of parameter adjustment by multiplying the partial derivative of the error with respect to the weight by a value between 0 and 1, thereby enabling the learning rate to be adjusted to increase a probability of parameter convergence, while reducing a training time.

In some embodiments, at operation 420, the procurement cost forecasting module determines an error contribution of each distinct model within the ensemble model, and the ensemble model parameters are adjusted based thereon. In some embodiments, ensemble model parameters may be adjusted by reducing a relative contribution (weighting) of a model whose cost forecast for the second period has an error greater than a threshold error. In some embodiments, ensemble model parameters may be adjusted by increasing a relative contribution (weighting) of a model whose cost forecast for the second period has an error less than a threshold error. In some embodiments, weightings of each model comprising the ensemble/composite model may be permuted to determine which combination of model weightings provides a minimum error over the historical period, and the model weightings of the ensemble model may be set to the weightings so determined.

Following operation 422, method 400 may return to operation 416, where the procurement cost forecasting module predicts an updated component procurement cost forecast using the updated composite machine learning model. Method 400 may repeat operations 416, 418, 420, and 422, until the error of the composite machine learning model decreases to below the error threshold. Upon the error of the predicted component procurement cost forecast decreasing to below the error threshold, the procurement cost forecasting platform may store the learned parameters of the composite machine learning model in a location of non-transitory memory, along with metadata indicating a component for which the composite machine learning model was trained, along with one or more additional details of the model. Method 400 may then proceed to employ the newly trained composite machine learning model to predict a procurement cost forecast for the component over a pre-determined future duration, as indicated at operation 406, operation 408, and operation 410, as discussed in more detail above. Upon determining the component procurement cost forecast over the pre-determined future duration for the component, method 400 may end.

In this way, method 400 enables a procurement cost forecasting platform to efficiently predict procurement cost forecasts using bespoke composite machine learning models, wherein a custom composite machine learning model may be used for each component, enabling greater specificity and accuracy of the procurement cost forecasts produced.

Turning to FIG. 5, an example of a graphical user interface (GUI) 500 is shown. GUI 500 shows a table view (as indicated by selectable interface element 516) of a procurement cost forecast for a plurality of components of a product, categorized according to BOM level 502. GUI 500 may be displayed to a client via a display subsystem of a client device by a procurement cost forecasting platform. In one embodiment, GUI 500 may be displayed to a client as part of method 300, as indicated at operation 320. GUI 500 comprises selectable interface element 518, which enables a user to select from one or more drop down menus, a product category, a product, and a BOM level of the one or more selected products. Procurement cost forecasts for the selection indicated by selectable interface element 518, are shown in procurement cost forecasts 514. In the example shown in FIG. 5, a client has selected the product category “industrial goods,” the product “Three Wheeled Trolley,” and the BOM level “Level-1” (a highest BOM level, showing each constituent BOM level of a product). Selectable interface element 518 enables a client to choose from a plurality of possible views, at a plurality of complexity levels. As an example, a client may select to view product procurement cost forecasts for products within a product category, or may view component level procurement cost forecasts for a selected BOM level. The freedom to select from numerous possible views of component procurement cost forecasts may enable a client to gain a better understanding of the cost fluctuations of various components, as well as their relative significance to the product costs and product category costs of a client's business.

Each product component included in GUI 500 includes a BOM level 502, a part number 504, a component/element description 506, an indication of the parent BOM level 508 of each component, a unit 510 indicating a size/amount defined for each component (e.g., each, sheet, liter, hour, kilogram, etc.). GUI 500 further shows a table view of historical component procurement costs 512, at regular intervals of time (e.g., monthly). The procurement costs shown in GUI 500 comprise the procurement cost of each component/BOM level as a percent of the total product cost (as indicated by element 520), therefore, for the three wheeled trolley, the procurement cost is by definition, 100% of the product cost, as the three wheeled trolley is the product. Further, GUI 500 includes a plurality of procurement cost forecasts 514 for the plurality of components. The plurality of procurement cost forecasts 514 shows procurement cost predictions, which in one example may be made using a composite machine learning model, as discussed in more detail above, with reference to FIG. 4, over a pre-determined duration of time (from October 2019 to May 2020, in the example shown in FIG. 5). The plurality of procurement cost forecasts are shown in a table view, wherein each column shows a predicted procurement cost for each of the plurality of components comprising the selected product (the three wheeled trolley), at pre-determined intervals of time (e.g., monthly). The procurement cost forecasts for non-atomic BOM levels (that is, BOM levels which may be further divided into one or more lower BOM levels or into components), may be determined by summing the procurement cost forecasts of the constituent BOM levels/constituent components. The client may select to view a chart/graph of the procurement cost forecasts by selecting selectable interface element 516. It will be appreciated that the current disclosure provides for various degrees of granularity in the procurement cost forecasts, wherein procurement cost forecasts may comprise substantially any interval of time (e.g., days, weeks, months, years), thereby enabling a client to view procurement cost forecasts of various degrees of granularity as it relates to time as well as level.

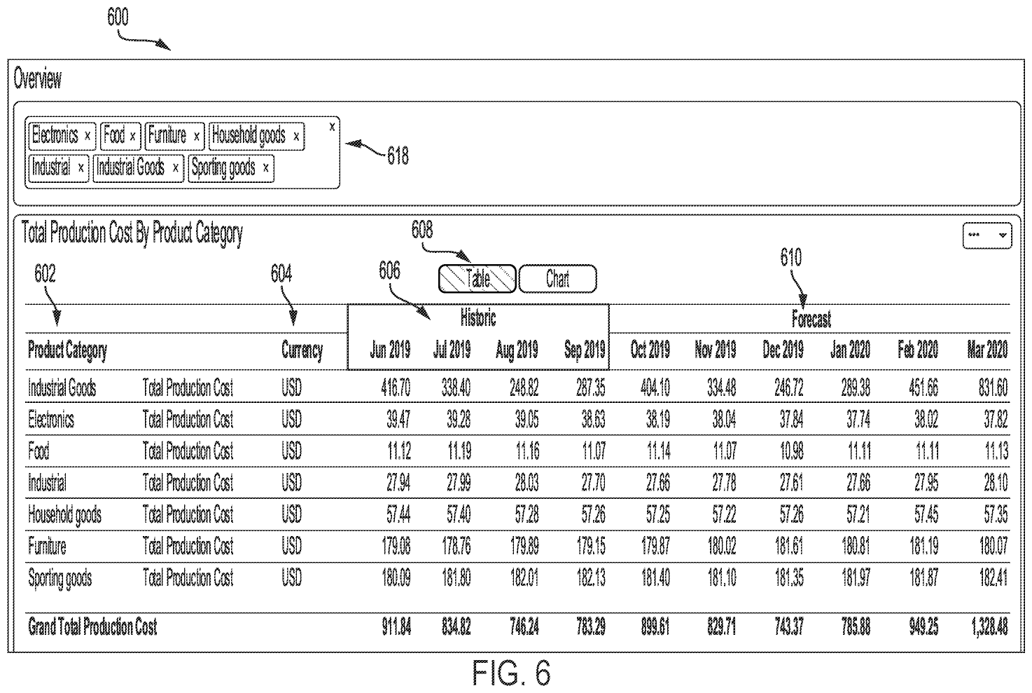

Turning to FIG. 6, an example of a graphical user interface (GUI) 600 is shown. GUI 600 shows a table view (as indicated by selectable interface element 608) of a procurement cost forecast 610 for a plurality of selected product categories 602. GUI 600 may be displayed to a client via a display subsystem of a client device, by a procurement cost forecasting platform. In one embodiment, GUI 600 may be displayed to a client as part of method 300, as indicated at operation 320. GUI 600 comprises selectable interface element 618, which enables a user to select or remove one or more product categories from GUI 600. Product categories may be defined by a user, via input received by the procurement cost forecasting platform from a client device of a client. Procurement cost forecasts 610 for the selected product categories indicated by selectable interface element 618, are shown. In the example shown in FIG. 6, a client has selected the product categories “Electronics,” “Food,” “Furniture,” “Household goods,” “Industrial goods”, and “Sporting goods.”

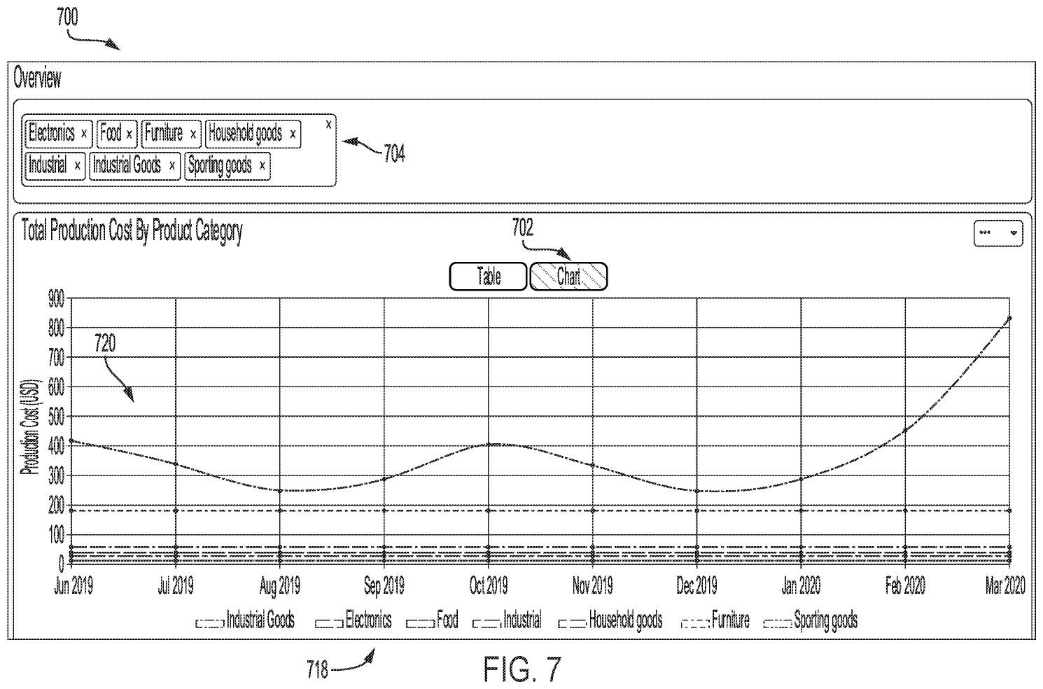

Each product category 602 included in GUI 600 includes a currency 604 for displaying the product category procurement costs, a table view of historical product category procurement costs 606, at regular intervals of time (e.g., monthly). Procurement costs for product categories may be determined as the sum of the procurement costs of each constituent product within the indicated product category, which may in turn comprise a sum of the procurement costs for each constituent component of each constituent product. Further, GUI 600 includes a plurality of procurement cost forecasts 610, for the plurality of product categories. The plurality of procurement cost forecasts 610 shows procurement cost predictions for each selected product category, which in one example may be made by aggregating constituent product procurement cost forecasts, as discussed in more detail above, with reference to FIG. 3, over a pre-determined duration of time (from October 2019 to May 2020, in the example shown in FIG. 5). The plurality of procurement cost forecasts are shown in a table view, wherein each column shows a predicted procurement cost for each of the plurality of selected product categories, at pre-determined intervals of time (e.g., monthly). The client may select to view a chart/graph of the procurement cost forecasts by selecting selectable interface element 608. FIG. 7 shows a chart view corresponding to the product category procurement cost forecasts shown in FIG. 6

Turning to FIG. 7, an example of a graphical user interface (GUI) 700 is shown. GUI 700 shows a chart view (as indicated by selectable interface element 702) of a procurement cost forecast 720 for a plurality of selected product categories 704. GUI 700 may be displayed to a client via a display subsystem of a client device, by a procurement cost forecasting platform. In one embodiment, GUI 700 may be displayed to a client as part of method 300, as indicated at operation 320. GUI 700 comprises selectable interface element 704, which enables a user to select or remove one or more product categories from procurement cost forecast 720. Procurement cost forecasts 720 comprise a color coded chart, showing procurement cost for the selected product categories as a continuous function of time. The y-axis of procurement cost forecast 720 indicates the production cost for each of the selected product categories (in USD), while the x-axis shows time, demarcated by month, extending from June 2019 (historical procurement cost data) to May 2020 (predicted/forecast procurement cost data). In the example shown in FIG. 7, a client has selected the product categories “Electronics,” “Food,” “Furniture,” “Household goods,” “Industrial,” “industrial goods”, and “Sporting goods.” Key 718, shown below procurement cost forecast 720, indicates which cost curves of procurement cost forecast 720 correspond to which product categories.

The disclosure also provides support for a method comprising: collecting component procurement cost data for a component, pre-processing the component procurement cost data to produce screened and tested component procurement cost data, acquiring historical data, pre-processing the historical data to produce screened and tested historical data, determining a component procurement cost forecast for the component over a pre-determined future duration using a composite machine learning model, the screened and tested component procurement cost data, and the screened and tested historical data, wherein the composite machine learning model comprises a plurality of models, wherein each of the plurality of models comprises one or more internal parameters, and one or more associated weights, and displaying the component procurement cost forecast to a user via a graphical user interface. In a first example of the method, the component procurement cost data comprises one or more purchase orders for the component, and wherein collecting component procurement cost data for the component comprises acquiring the one or more purchase orders from an enterprise device. In a second example of the method, optionally including the first example, pre-processing the component procurement cost data to produce screened and tested component procurement cost data comprises: determining if a purchase order of the one or more purchase orders includes a timestamp, and responding to the purchase order not including a timestamp by removing the purchase order from the component procurement cost data to produce the screened and tested component procurement cost data. In a third example of the method, optionally including any of the first and second examples, wherein pre-processing the historical data to produce screened and tested historical data comprises: filtering the historical data using one or more pre-determined filters. In a fourth example of the method, optionally including any of the first through third examples, wherein the historical data comprises one or more of market data, and economic data. In a fifth example of the method, optionally including any of the first through fourth examples, wherein the plurality of models includes one or more of a deep neural network, a recurrent neural network; an ensemble approach including autoregressive integrated moving average (ARIMA), correlation analysis, vector autoregression (VAR), decision trees (e.g. random forest), generalized autoregressive conditional heteroscedasticity (GARCH) and exponential smoothing. In a sixth example of the method, optionally including any of the first through fifth examples, wherein determining the component procurement cost forecast for the component over the pre-determined future duration using the composite machine learning model, the screened and tested component procurement cost data, and the screened and tested historical data, comprises: determining if the composite machine learning model was previously trained to predict procurement costs of the component, and responding to the composite machine learning model having been previously trained to predict procurement costs of the component by: accessing a memory location where the composite machine learning model is stored, inputting the screened and tested component procurement cost data and the screened and tested historical data into the plurality of models of the composite machine learning model, mapping the screened and tested component procurement cost data and the screened and tested historical data to a plurality of component procurement cost forecasts using the plurality of models, and aggregating the plurality of component procurement cost forecasts to produce the component procurement cost forecast. In a seventh example of the method, optionally including any of the first through sixth examples, aggregating the plurality of component procurement cost forecasts to produce the component procurement cost forecast comprises: determining a weighted average of the plurality of component procurement cost forecasts by multiplying each of the plurality of component procurement cost forecasts by the one or more associated weights to produce a plurality of weighted component procurement cost forecasts, and averaging the plurality of weighted component procurement cost forecasts to produce the bill of material procurement cost forecast. In an eighth example of the method, optionally including any of the first through seventh examples, wherein determining the component procurement cost forecast for the component over the pre-determined future duration using the composite machine learning model, the screened and tested component procurement cost data, and the screened and tested historical data, comprises: determining if the composite machine learning model was previously trained to predict procurement costs of the component, and responding to the composite machine learning model having not been previously trained to predict procurement costs of the component by: separating the screened and tested component procurement cost data and the screened and tested historical data into a first period and a second period, wherein the first period and the second period do not overlap in time, and wherein the first period immediately precedes the second period, initializing the composite machine learning model, mapping the screened and tested component procurement cost data and the screened and tested historical data, of the first period, to a predicted procurement cost forecast for the second period, determining an error of the predicted procurement cost forecast based on the screened and tested component procurement cost data of the second period, and adjusting one or more parameters of the composite machine learning model based on the error. In a ninth example of the method, optionally including any of the first through eighth examples, the method further comprising: responding to the error being less than a threshold by: storing the composite machine learning model in a location of non-transitory memory, inputting the screened and tested component procurement cost data and the screened and tested historical data into the plurality of models of the composite machine learning model, mapping the screened and tested component procurement cost data and the screened and tested historical data to a plurality of component procurement cost forecasts using the plurality of models, and determining a weighted average of the plurality of component procurement cost forecasts, and setting the component procurement cost forecast based on the weighted average of the plurality of component procurement cost forecasts. In a tenth example of the method, optionally including any of the first through ninth examples, displaying the component procurement cost forecast to the user via the graphical user interface comprises: displaying a table within the graphical user interface, wherein the table comprises a plurality of predicted component procurement costs for each of a plurality of pre-determined time points over the pre-determined future duration.

The disclosure also provides support for a procurement cost forecasting platform comprising: a communication subsystem, wherein the communication subsystem communicably couples the procurement cost forecasting platform with a client device, one or more historical data sources, and an enterprise device, a data holding subsystem comprising instructions, and a logic subsystem, wherein, when executing the instructions, the logic subsystem is configured to: collect component procurement cost data of a component from the enterprise device, pre-process the component procurement cost data to produce screened and tested component procurement cost data, acquire historical data from the one or more historical data sources, pre-process the historical data to produce screened and tested historical data, determine a component procurement cost forecast for a component over a pre-determined future duration using a composite machine learning model, the screened and tested component procurement cost data, and the screened and tested historical data, and transmit the component procurement cost forecast to the client device via the communication subsystem. In a first example of the system, the one or more historical data sources comprises one or more of a market data server and an economic data server, and wherein the historical data comprises one or more of market data, trade data, and economic data. In a second example of the system, optionally including the first example, when executing the instructions, the logic subsystem is further configured to: determine a confidence level and error rate of the component procurement cost forecast, and transmit the confidence level to the client device via the communication subsystem.

The disclosure also provides support for a method for a procurement cost forecasting platform comprising: collecting first component procurement cost data for a first component from an enterprise device of a client, pre-processing the first component procurement cost data to produce screened and tested first component procurement cost data, mapping the screened and tested first component procurement cost data to a first plurality of component procurement cost forecasts using a plurality of models, aggregating the first plurality of component procurement cost forecasts to produce a first component procurement cost forecast, and displaying the first component procurement cost forecast to the client via a graphical user interface of a client device. In a first example of the method, each of the first plurality of component procurement cost forecasts comprises a plurality of predicted component procurement costs over a pre-determined future duration, wherein the first plurality of predicted component procurement costs are separated by a pre-determined interval of time. In a second example of the method, optionally including the first example, aggregating the first plurality of component procurement cost forecasts to produce the first component procurement cost forecast comprises: determining a weighted average of the first plurality of component procurement cost forecasts by multiplying the first plurality of component procurement cost forecasts by a plurality of associated weights to produce a plurality of weighted component procurement cost forecasts, and averaging the plurality of weighted component procurement cost forecasts to produce the first component procurement cost forecast. In a third example of the method, optionally including the first and second examples, the method further comprising: collecting second component procurement cost data for a second component from the enterprise device of the client, pre-processing the second component procurement cost data to produce screened and tested second component procurement cost data, mapping the screened and tested second component procurement cost data to a second plurality of component procurement cost forecasts using the plurality of models, aggregating the second plurality of component procurement cost forecasts to produce a second component procurement cost forecast, and adding the second component procurement cost forecast with the first component procurement cost forecast based on a bill-of-materials level (BOM level) to produce a BOM level procurement cost forecast. In a fourth example of the method, optionally including the first through third examples, when the BOM level procurement cost forecast comprises a first BOM level procurement cost forecast, and wherein the method further comprises: aggregating the first BOM level procurement cost forecast with at least a second BOM level procurement cost forecast to produce a product procurement cost forecast. In a fifth example of the method, optionally including the first through fourth examples, the product procurement cost forecast comprises a first product procurement cost forecast, and wherein the method further comprises: aggregating the first product procurement cost forecast with at least a second product procurement cost forecast to produce a product category forecast, wherein the first product and the second product belong to a same product category.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer/machine configured by a computer program (machine readable/executable instructions)) which at least partially carries out processes and/or devices described herein, or a microprocessor configured by a computer program which at least partially carries out processes and/or devices described herein), circuitry forming a memory device (e.g., forms of random access memory), and/or circuits forming a communications device. (e.g., a modem, communications switch, or the like).

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the server 202 and/or client device 112 described with reference to FIG. 2. The methods may be performed by executing stored instructions on machine readable storage media with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Aspects of the present disclosure are described herein with reference to flowchart illustrations and/or block diagrams of methods, apparatus, and computer program products according to the embodiments disclosed herein. Insofar as such block diagrams, flowcharts, and/or examples contain one or more functions and/or operations, it will be understood by those of skill in the art that each function and/or operation within such block diagrams, flowcharts, or examples can be implemented, individually and/or collectively, by computer readable instructions using a wide range of hardware, software, firmware, or virtually any combination thereof. The described systems are exemplary in nature and may include additional elements and/or omit elements. The subject matter of the present disclosure includes all novel and non-obvious combinations and sub-combinations of the various systems and configurations, and other features, functions, and/or properties disclosed.

As used herein, the terms “system” or “module” may include a hardware and/or software system that operates to perform one or more functions. For example, a module or system may include a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. Various modules or units shown in the attached figures may represent the hardware that operates based on software or hardwired instructions, the software that directs hardware to perform the operations, or a combination thereof.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method comprising:
collecting component procurement cost data for a component;
pre-processing the component procurement cost data to produce screened and tested component procurement cost data;
acquiring historical data;
pre-processing the historical data to produce screened and tested historical data;
determining a component procurement cost forecast for the component over a pre-determined future duration using a composite machine learning model, the screened and tested component procurement cost data, and the screened and tested historical data, wherein the composite machine learning model comprises a plurality of models, wherein each of the plurality of models comprises one or more internal parameters, and one or more associated weights; and
displaying the component procurement cost forecast to a user via a graphical user interface.

2. The method of claim 1, wherein the component procurement cost data comprises one or more purchase orders for the component, and wherein collecting component procurement cost data for the component comprises acquiring the one or more purchase orders from an enterprise device.

3. The method of claim 2, wherein pre-processing the component procurement cost data to produce screened and tested component procurement cost data comprises:
determining if a purchase order of the one or more purchase orders includes a timestamp; and
responding to the purchase order not including the timestamp by removing the purchase order from the component procurement cost data to produce the screened and tested component procurement cost data.

4. The method of claim 1, wherein pre-processing the historical data to produce screened and tested historical data comprises:
filtering the historical data using one or more pre-determined filters.

5. The method of claim 1, wherein the historical data comprises one or more of market data, and economic data.

6. The method of claim 1, wherein the plurality of models includes one or more of a deep neural network, a recurrent neural network, an ensemble approach including autoregressive integrated moving average (ARIMA), correlation analysis, vector autoregression (VAR), a decision tree, generalized autoregressive conditional heteroscedasticity (GARCH), and exponential smoothing.

7. The method of claim 1, wherein determining the component procurement cost forecast for the component over the pre-determined future duration using the composite machine learning model, the screened and tested component procurement cost data, and the screened and tested historical data, comprises:
determining if the composite machine learning model was previously trained to predict procurement costs of the component; and
responding to the composite machine learning model having been previously trained to predict procurement costs of the component by:
accessing a memory location where the composite machine learning model is stored;
inputting the screened and tested component procurement cost data and the screened and tested historical data into the plurality of models of the composite machine learning model;
mapping the screened and tested component procurement cost data and the screened and tested historical data to a plurality of component procurement cost forecasts using the plurality of models; and
aggregating the plurality of component procurement cost forecasts to produce the component procurement cost forecast.

8. The method of claim 7, wherein aggregating the plurality of component procurement cost forecasts to produce the component procurement cost forecast comprises:
determining a weighted average of the plurality of component procurement cost forecasts by multiplying each of the plurality of component procurement cost forecasts by the one or more associated weights to produce a plurality of weighted component procurement cost forecasts; and
averaging the plurality of weighted component procurement cost forecasts to produce a bill of material procurement cost forecast.

9. The method of claim 1, wherein determining the component procurement cost forecast for the component over the pre-determined future duration using the composite machine learning model, the screened and tested component procurement cost data, and the screened and tested historical data, comprises:
determining if the composite machine learning model was previously trained to predict procurement costs of the component; and
responding to the composite machine learning model having not been previously trained to predict procurement costs of the component by:
separating the screened and tested component procurement cost data and the screened and tested historical data into a first period and a second period, wherein the first period and the second period do not overlap in time, and wherein the first period immediately precedes the second period;
initializing the composite machine learning model;
mapping the screened and tested component procurement cost data and the screened and tested historical data, of the first period, to a predicted procurement cost forecast for the second period;
determining an error of the predicted procurement cost forecast based on the screened and tested component procurement cost data of the second period; and
adjusting one or more parameters of the composite machine learning model based on the error.

10. The method of claim 9, the method further comprising:
responding to the error being less than a threshold by:
storing the composite machine learning model in a location of non-transitory memory;
inputting the screened and tested component procurement cost data and the screened and tested historical data into the plurality of models of the composite machine learning model;
mapping the screened and tested component procurement cost data and the screened and tested historical data to a plurality of component procurement cost forecasts using the plurality of models; and
determining a weighted average of the plurality of component procurement cost forecasts; and
setting the component procurement cost forecast based on the weighted average of the plurality of component procurement cost forecasts.

11. The method of claim 1, wherein displaying the component procurement cost forecast to the user via the graphical user interface comprises:
displaying a table within the graphical user interface, wherein the table comprises a plurality of predicted component procurement costs for each of a plurality of pre-determined time points over the pre-determined future duration.

12. A procurement cost forecasting platform comprising:
a communication subsystem, wherein the communication subsystem communicably couples the procurement cost forecasting platform with a client device, one or more historical data sources, and an enterprise device;
a data holding subsystem comprising instructions; and
a logic subsystem, wherein, when executing the instructions, the logic subsystem is configured to:
collect component procurement cost data of a component from the enterprise device;
pre-process the component procurement cost data to produce screened and tested component procurement cost data;
acquire historical data from the one or more historical data sources;
pre-process the historical data to produce screened and tested historical data;
determine a component procurement cost forecast for a component over a pre-determined future duration using a composite machine learning model, the screened and tested component procurement cost data, and the screened and tested historical data; and
transmit the component procurement cost forecast to the client device via the communication subsystem.

13. The procurement cost forecasting platform of claim 12, wherein the one or more historical data sources comprises one or more of a market data server and an economic data server, and wherein the historical data comprises one or more of market data, trade data, and economic data.

14. The procurement cost forecasting platform of claim 12, wherein, when executing the instructions, the logic subsystem is further configured to:
determine a confidence level and error rate of the component procurement cost forecast; and
transmit the confidence level to the client device via the communication subsystem.

15. A method for a procurement cost forecasting platform comprising:
collecting first component procurement cost data for a first component from an enterprise device of a client;
pre-processing the first component procurement cost data to produce screened and tested first component procurement cost data;
mapping the screened and tested first component procurement cost data to a first plurality of component procurement cost forecasts using a plurality of models;
aggregating the first plurality of component procurement cost forecasts to produce a first component procurement cost forecast; and
displaying the first component procurement cost forecast to the client via a graphical user interface of a client device.

16. The method of claim 15, wherein each of the first plurality of component procurement cost forecasts comprises a plurality of predicted component procurement costs over a pre-determined future duration, wherein the first plurality of predicted component procurement costs are separated by a pre-determined interval of time.

17. The method of claim 15, wherein aggregating the first plurality of component procurement cost forecasts to produce the first component procurement cost forecast comprises:
determining a weighted average of the first plurality of component procurement cost forecasts by multiplying the first plurality of component procurement cost forecasts by a plurality of associated weights to produce a plurality of weighted component procurement cost forecasts; and
averaging the plurality of weighted component procurement cost forecasts to produce the first component procurement cost forecast.

18. The method of claim 15, the method further comprising:
collecting second component procurement cost data for a second component from the enterprise device of the client;
pre-processing the second component procurement cost data to produce screened and tested second component procurement cost data;
mapping the screened and tested second component procurement cost data to a second plurality of component procurement cost forecasts using the plurality of models;
aggregating the second plurality of component procurement cost forecasts to produce a second component procurement cost forecast; and
adding the second component procurement cost forecast with the first component procurement cost forecast based on a bill-of-materials level (BOM level) to produce a BOM level procurement cost forecast.

19. The method of claim 18, when the BOM level procurement cost forecast comprises a first BOM level procurement cost forecast, and wherein the method further comprises:
aggregating the first BOM level procurement cost forecast with at least a second BOM level procurement cost forecast to produce a product procurement cost forecast.

20. The method of claim 19, wherein the product procurement cost forecast comprises a first product procurement cost forecast, and wherein the method further comprises:
aggregating the first product procurement cost forecast with at least a second product procurement cost forecast to produce a product category forecast, wherein the first product and the second product belong to a same product category.

21.-22. (canceled)
